(19) United States
(12) Patent Application Publication
(10) Pub. No.: US 2015/0180990 A1
(43) Pub. Date: Jun. 25, 2015

(54) METHODS AND SYSTEMS FOR DETERMINING USER ONLINE TIME

(71) Applicant: TENCENT TECHNOLOGY (SHENZHEN) COMPANY LIMITED, Shenzhen (CN)

(72) Inventors: FUXIAN DING, Shenzhen (CN); ZHONGWEI LI, Shenzhen (CN)

(73) Assignee: TENCENT TECHNOLOGY (SHENZHEN) COMPANY LIMITED

(21) Appl. No.: 14/640,068

(22) Filed: Mar. 6, 2015

Related U.S. Application Data
(63) Continuation of application No. PCT/CN2014/076039, filed on Jan. 15, 2014.

(30) Foreign Application Priority Data
May 22, 2013 (CN) 2013-10192082.X

(51) Int. Cl. H04L 29/08; H04L 12/26

(52) U.S. Cl. CPC H04L 67/22; H04L 43/0876

(57) ABSTRACT

A method and system for determining user online time are disclosed. The method includes determining a first time instance, the first time instance corresponding to a first user operation during one user visit and determining a second time instance, the second time instance corresponding to a last user operation during the user visit. The method further includes determining a difference between the first time instance and the second time instance and adding the difference to the user online time. The disclosed method and system enable websites to record user online time with more accuracy.

### CROSS-REFERENCES TO RELATED APPLICATIONS

### Related Applications

This application is a continuation application of PCT Patent Application No. PCT/CN2014/076039, filed on Jan. 15, 2014, which is based upon and claims the benefit of priority from Chinese Patent Application No. 201310192082.X, filed on May 22, 2013, the entire contents of which are incorporated herein by reference.

### FIELD OF THE INVENTION

The present disclosure relates to network technologies and, more particularly, to methods and systems for determining user online time.

### BACKGROUND

A website often needs to evaluate user behaviors or charge for certain types of usage. A website therefore often needs to determine the length of a user's online time. A commonly used method is for a website to record a user's sign-in time when the user signs in, and to record the user's sign-off time when the user signs off The website may then determine that the difference between the sign-in and sign-oft times is the length of the user's online time.

When multiple websites share one sign-in platform, a user may visit multiple websites after signing in one time. As such, each websites may not be able to use the sign-in and sign-off times to determine the length of user online time.

The disclosed method and system are directed to solve one or more problems set forth above and other problems.

### BRIEF SUMMARY OF THE DISCLOSURE

Embodiments consistent with the present disclosure provide a method, system, user terminal, or a server for determining user online time. Embodiments consistent with the present disclosure provide improved estimates of user online time.

One aspect of the present disclosure provides a method for determining user online time. The method includes determining a first time instance, the first time instance corresponding to a first user operation during one user visit and determining a second time instance, the second time instance corresponding to a last user operation during the user visit. The method further includes determining a difference between the first time instance and the second time instance and adding the difference to the user online time.

Another aspect of the present disclosure provides a system for determining user online time. The system includes a server for implementing functions supporting determination of the user online time. The server includes an obtaining module configured to obtain a first time instance, the first time instance corresponding to a first user operation during one user visit and to obtain a second time instance, the second time instance corresponding to a last user operation during the user visit. The server further includes a computing module configure to determine a difference between the first time instance and the second time instance and an accumulating module configured to add the difference to the user online time.

Embodiments consistent with the present disclosure determine user online time based on the time of the user's first operation and the time of the user's last operation in one session. Embodiments consistent with the present disclosure may calculate the time difference between the times of the first operation and the last operation. Embodiments consistent with the present disclosure may further add the length of the time difference to the user's total online time. Embodiments consistent with the present disclosure may determine user online time without checking the sign-in time and sign-off time of a user.

Other aspects of the present disclosure can be understood by those skilled in the art in light of the description, the claims, and the drawings of the present disclosure.

### BRIEF DESCRIPTION OF THE DRAWINGS

To illustrate embodiments of the invention, the following are a few drawings illustrating embodiments consistent with the present disclosure.

FIG. 1 is a flowchart of a method for determining user online time implemented by an exemplary embodiment consistent with the present disclosure;

FIG. 2a is another flowchart of a method for determining user online time implemented by an exemplary embodiment consistent with the present disclosure;

FIG. 2b is a chart of a user session managed by an exemplary embodiment consistent with the present disclosure;

FIG. 3 is another flowchart of a method for determining user online time implemented by an exemplary embodiment consistent with the present disclosure;

FIG. 4 is a schematic diagram of an exemplary system for determining user online time consistent with the present disclosure;

FIG. 5 is another schematic diagram of an exemplary system for determining user online time consistent with the present disclosure;

FIG. 6 is another schematic diagram of an exemplary system for determining user online time consistent with the present disclosure;

FIG. 7 illustrates an exemplary operating environment incorporating certain disclosed embodiments; and

FIG. 8 illustrates a block diagram of an exemplary computer system consistent with the disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

In the present disclosure, a user terminal, a terminal, and a terminal device are used interchangeably to refer to any computing device that may communicate with another computing device. Exemplary terminals may include laptop computers, smartphones, tablet computers, etc. Further, a user session or a user visit may refer to any group of operations a user performs over a period of time on a website. The website may determine what the time frame of a user visit/session is (e.g. 20 minutes). If the user has activities on the site within that time period, it is still considered one user visit/session. If the user has no activity on the site after the allotted time period has expired, then the website may count the subsequent operation as in a separate user visit/session.

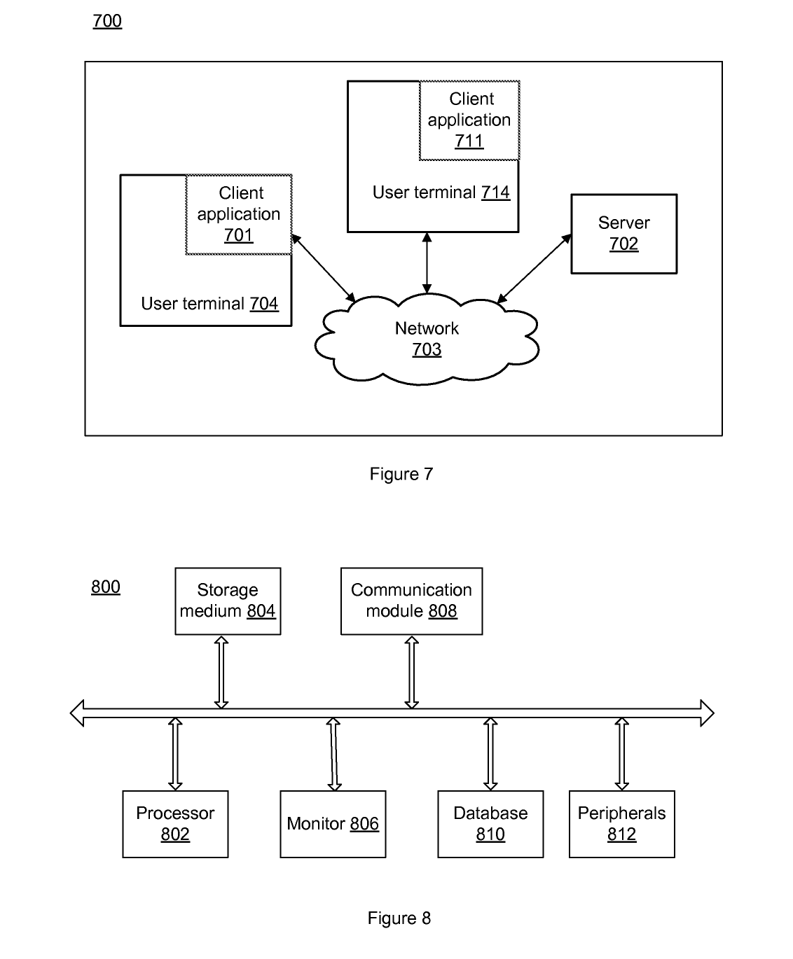

FIG. 7 illustrates an exemplary online computer environment 700 incorporating certain disclosed embodiments. As shown in FIG. 7, environment 700 may include user terminals 704 and 714, a network 703, and a server 702. The network 703 may include any appropriate type of communication network for providing network connections to the user terminals 704 and 714, and the server 702. For example, network 703 may include the Internet, LAN (Local Area Network), or other types of computer networks or telecommunication networks, either wired or wireless.

A server 702, as used herein, may refer to one or more server computers configured to provide certain functionalities, which may require any user accessing the services to authenticate to the server before the access. The server 702 may also include one or more processors to execute computer programs in parallel. The server 702 may include any appropriate server computers configured to provide certain server functionalities, such as storing or processing data related to users' sign-in times, sign-off times, operation times, etc. Although only one server is shown, any number of servers can be included. The server 702 may operate in a cloud or non-cloud computing environment.

User terminals 704 and 714 may include any appropriate type of network computing devices, such as PCs, tablet computers, smartphones, network TVs, etc. User terminals 704 and 714 may include one or more client applications 701 and 711. The client applications 701 and 711, as used herein, may include any appropriate software application, hardware application, or a combination thereof to achieve certain client functionalities, such as browsing a webpage online, signing into a website, etc. For example, client applications 701 and 711 may be the Internet Explorer application, which may access websites and webpages. Any number of client applications 701 and 711 may be included in the environment 700.

User terminals 704/714 and server 702 may be implemented on any appropriate computing platform. FIG. 8 illustrates a block diagram of an exemplary computer system 800 capable of implementing user terminals 704/714 and server 702.

As shown in FIG. 8, computer system 800 may include a processor 802, storage medium 804, a monitor 806, a communication module 808, a database 810, and peripherals 812. Certain devices may be omitted and other devices may be included.

Processor 802 may include any appropriate processor or processors. Further, processor 802 can include multiple cores for multi-thread or parallel processing. Storage medium 804 may include memory modules, such as Read-only Memory (ROM), Random Access Memory (RAM), flash memory modules, and erasable and rewritable memory, and mass storages, such as CD-ROM, U-disk, and hard disk, etc. Storage medium 804 may store computer programs for implementing various processes, when executed by processor 802.

Further, peripherals 812 may include I/O devices such as a keyboard and a mouse. Communication module 808 may include network devices for establishing connections through the communication network 703. Database 810 may include one or more databases for storing certain data and for performing certain operations on the stored data, such as database searching.

In operation, the server 702 may obtain and process data related to determining online time for user terminals 704/714. For example, the server 702 may use processor 802 to check whether a user who signed in on user terminal 704 has performed any new operation. If so, the processor 802 may determine that the user is still online.

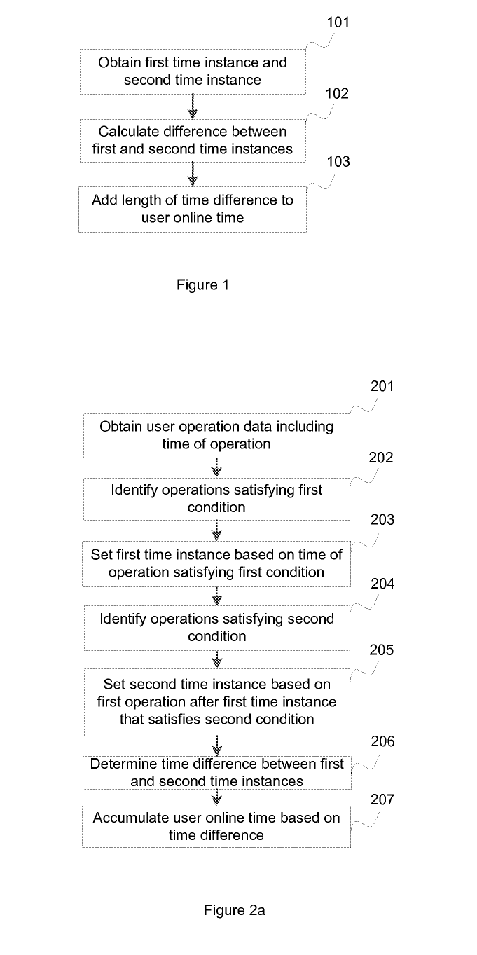

FIG. 1 is a flow chart of a method for determining user online time implemented by embodiments consistent with the present disclosure. The method describe in relation to FIG. 1 includes steps 101-103. In step 101, a server of the system for determining user online time may obtain a first time instance and a second time instance. The server may record the time of the first operation performed by a user in one user session as the first time instance. The server may record the time of the last operation performed by the user in one session as the second time instance. In step 102, the server may calculate the length of time between the first time instance and the second time instance. In step 103, the server may add the length of time calculated in step 102 to the total length of time of the user session.

Embodiments consistent with the present disclosure determine user online time based on the time of the user's first operation and the time of the user's last operation in one session. Embodiments consistent with the present disclosure may calculate the time difference between the times of the first operation and the last operation. Embodiments consistent with the present disclosure may further add the length of the time difference to the user's total online time. Embodiments consistent with the present disclosure may determine user online time without checking the sign-in time and sign-off time of a user.

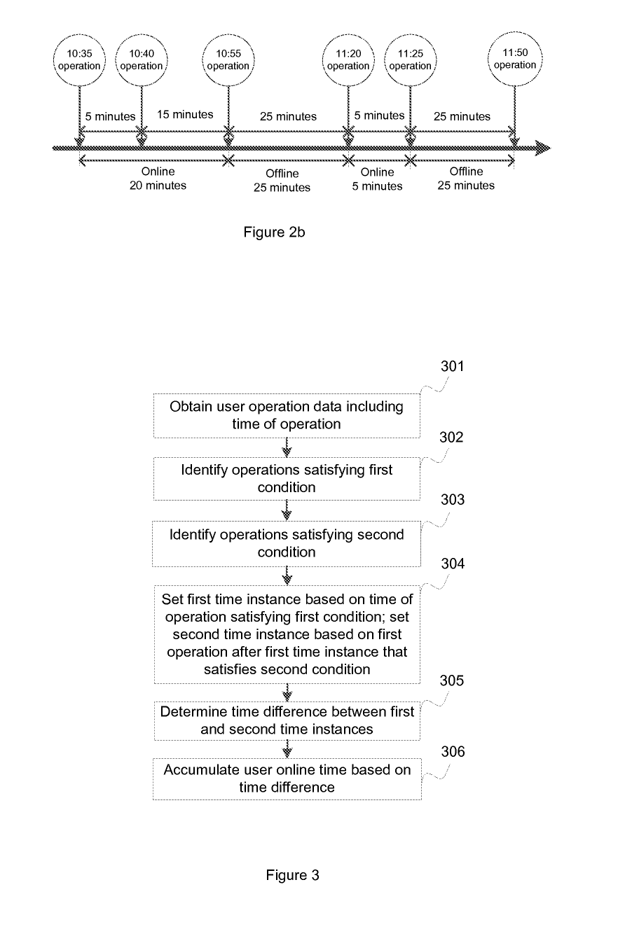

FIG. 2 shows another flow chart of a method for determining user online time implemented by embodiments consistent with the present disclosure. The method shown in FIG. 2 includes steps 201-207. The example described in relation to FIG. 2 illustrates how a blog website determines user online time consistent with the present disclosure.

In step 201, the system for determining user online time may obtain data related to a group of operations performed by a user. The data include the time of each operation. A server of the system for determining user online time may obtain data related to a group of operations performed by a user. The data include the time of each operation. The user operations include actions such as clicking on a webpage, scrolling on a webpage, exchanging data through a webpage, changing webpages, etc. In one embodiment, the system may be triggered by a link or a JavaScript embedded in a webpage. Once a user performs a qualified operation, the system for determining user online time may obtain data such as certain data related to the user operations for further processing.

For example, a user performed a group of operations on a blog website (e.g., blog.qq.com) between 10:00 AM and 12:00 PM on May 12, 2013. As shown in FIG. 2b, in this example, the user performed operations at 10:35 AM, 10:40 AM, 10:55 AM, 11:20 AM, 11:25 AM, and 11:50 AM. It should be noted that a website may record user operations for any given time period to evaluate the usage of the website. A website may record user operations in real time. A website may also set the time for a user's first visit to the site as the beginning of the time period to record user operations.

In step 202, the system for determining user online time may check whether the operations in the group of operations satisfy a first condition. The server of the system for determining user online time may check whether the operations in the group of operations satisfy the first condition. The first condition may include whether the time for an operation is after the time for a previous operation for more than a given threshold amount of time. The system for determining user online time may set the threshold. For example, the threshold may be 20 minutes. That is, if a user has not performed an operation on the website for over 20 minutes, the system for determining user online time may determine that the use has gone offline. The system may refer to the threshold time (20 minutes) after each operation satisfying the first condition as a user visit.

In the blog website example, the system may determine that the user had operations at 11:20 AM and 11:50 AM that satisfy the first condition (more than 20 minutes after the previous operation). As such, the user had three operations, at 10:35 AM, 11:20 AM, and 11:50 AM, respectively, that satisfy the first condition (more than 20 minutes after the previous operation). That is, there are three user visits to the website in this example.

In step 203, the system for determining user online time may set the time for each operation that satisfies the first condition as the first time instance. The server of the system for determining user online time may set the time for each operation that satisfies the first condition as the first time instance. In the blog website example, the system may set 10:35 AM, 11:20 AM, and 11:50 AM as the first time instances for each user visit.

In step 204, the system for determining user online time may check whether the operations after the operations meeting the first condition satisfy a second condition. The server of the system for determining user online time may check whether the after the operations meeting the first condition satisfy the second condition. The second condition may include whether the time for an operation is before the time for a next operation for more than a given threshold amount of time. The system for determining user online time may set the threshold, which may correspond to the time threshold for going offline.

For example, the system may check the operations to identify the ones satisfying the second condition after step 202. In step 202, three operations (at 10:35 AM, 11:20 AM, and 11:50 AM) were found to satisfy the first condition. For the first operation at 10:35 AM, two later operations, at 10:55 AM and 11:25 AM respectively, satisfy the second condition. For the second operation at 11:20 AM, the operation at 11:25 AM satisfies the second condition. For the third operation at 11:50 AM, because in this example, the website was checking operations between LOAM and 12 PM, there is no operation after 12:00 PM. In other scenarios, the user may have operations after 12 PM.

In step 205, the system for determining user online time may set the time corresponding to the first operation satisfying the second condition for each visit as the second time instance. The server of the system for determining user online time may set the time corresponding to the first operation satisfying the second condition for each visit as the second time instance. For example, for the operation at 10:35 AM, the system found two later operations, at 10:55 AM and 11:25 AM respectively, satisfy the second condition. The system may set the earlier of the two operations as the second time instance, which is 10:55 AM. For the operation at 11:20 AM, only the operation at 11:25 AM satisfies the second condition. The system may then set 11:25 AM as the second time instance.

In step 206, the system for determining user online time may calculate the time difference between the first instances and the second instances for each user visit. For the first user visit starting at time 10:35 AM, the time difference between the first (10:35 AM) and second (10:55 AM) time instances is 20 minutes. For the second user visit, the time difference between the first (11:20 AM) and second (11:25 AM) time instances is 5 minutes.

In step 207, the system for determining user online time may add the time difference to the user's total online time. In the above example, the system may determine that on May 12, 2013, between 10:00 AM and 12:00 PM, the user's total online time is 20+5=25 minutes.

In the above example, the system for determining user online time determines a user's online time based on the second time instance (which is the time of the first operation satisfying the second condition in a user visit) in a user visit, which is based on the first operation in a given time period. In other cases, the system may determine the online time based on the last operation in a given time period. In addition, when a system records user operations in real time, it may also determine the first and second time instances based on whether the time difference between the two adjacent operations exceeds a threshold value.

Embodiments consistent with the present disclosure determine user online time based on the time of the user's first operation and the time of the user's last operation in one user session. Embodiments consistent with the present disclosure may define the time for the first operation as the first time instance and the time for the last operation as the second time instance. Embodiments consistent with the present disclosure may calculate the time difference between the time instances. Embodiments consistent with the present disclosure may further add the length of the time difference to the user's total online time. Embodiments consistent with the present disclosure may determine user online time without checking the sign-in time and sign-off time of a user.

FIG. 3 shows another flow chart of a method for determining user online time implemented by embodiments consistent with the present disclosure. The method shown in FIG. 3 includes steps 301-306. The example described in relation to FIG. 3 illustrates how a blog website determines user online time consistent with the present disclosure.

In step 301, the system for determining user online time may obtain data related to a group of operations performed by a user. The data include the time of each operation. A server of the system for determining user online time may obtain data related to a group of operations performed by a user. The data include the time of each operation. The user operations include clicking on a webpage, scrolling on a webpage, exchanging data through a webpage, changing webpages, etc. For example, a user performed a group of operations on a blog website (e.g., blog.qq.com) between 10:00 AM and 12:00 PM on May 12, 2013. As shown in FIG. 2b, in this example, the user performed operations at 10:35 AM, 10:40 AM, 10:55 AM, 11:20 AM, 11:25 AM, and 11:50 AM. It should be noted that a website may record user operations for any given time period to evaluate the usage of the website. A website may record user operations in real time. A website may also set the time for a user's first visit to the site as the beginning of the time period to record user operations.

In step 302, the system for determining user online time may check whether the operations in the group of operations satisfy a first condition. The server of the system for determining user online time may check whether the operations in the group of operations satisfy the first condition. The first condition may include whether the time for an operation is after the time for the previous operation for more than a given threshold amount of time. The system for determining user online time may set the threshold. For example, the threshold may be 20 minutes. That is, if a user has not performed an operation on the website for over 20 minutes, the system for determining user online time may determine that the use has gone offline. The system may refer to the threshold time (20 minutes) after each operation satisfying the first condition as a user visit.

In the blog website example, the system may determine that the user had operations at 11:20 AM and 11:50 AM that satisfy the first condition (more than 20 minutes after the previous operation). As such, the user has three operations, at 10:35 AM, 11:20 AM, and 11:50 AM, respectively, that satisfy the first condition (more than 20 minutes after the previous operation). That is, there are three user visits to the website in this example.

In step 303, the system for determining user online time may check whether the operations after the operations meeting the first condition satisfy a second condition. The server of the system for determining user online time may check whether the after the operations meeting the first condition satisfy the second condition. The second condition may include whether the time for an operation is before the time for a next operation for more than a given threshold amount of time. The system for determining user online time may set the threshold, which may correspond to the time threshold for going offline.

For example, the system may check the operations to identify the ones satisfying the second condition after step 202. In step 302, three operations were found to satisfy the first condition. For the first operation at 10:35 AM, two later operations, at 10:55 AM and 11:25AM respectively, satisfy the second condition. For the second operation at 11:20 AM, the operation at 11:25 AM satisfies the second condition. For the third operation at 11:50 AM, because in this example, the website was checking operations between 10 AM and 12 PM, there is no operation after 12:00 PM. In other scenarios, the user may have operations after 12 PM.

In step 304, the system for determining user online time may set the time for each operation that satisfies the first condition as the first instance. The server of the system for determining user online time may set the time for each operation that satisfies the first condition as the first instance. In the blog website example, the system may set 10:35 AM, 11:20 AM, and 11:50 AM as the first instances for each user visit.

Further, the system for determining user online time may set the time corresponding to the first operation satisfying the second condition for each visit as the second instance. The server of the system for determining user online time may set the time corresponding to the first operation satisfying the second condition for each visit as the second instance. For example, for the operation at 10:35 AM, the system found two later operations, at 10:55 AM and 11:25 AM respectively, satisfy the second condition. The system may set the earlier of the two operations as the second instance, which is 10:55 AM. For the operation at 11:20 AM, only the operation at 11:25 AM satisfies the second condition. The system may then set 11:25 AM as the second instance.

In step 305, the system for determining user online time may calculate the time difference between the first instances and the second instances for each user visit. For the first user visit starting at time 10:35 AM, the time difference between the first (10:35 AM) and second (10:55 AM) time instances is 20 minutes. For the second user visit, the time difference between the first (11:20 AM) and second (11:25 AM) time instances is 5 minutes.

In step 306, the system for determining user online time may add the time difference to the user's total online time. In the above example, the system may determine that on May 12, 2013, between 10:00 AM and 12:00PM, the user's total online time is 20+5=25 minutes.

In the above example, the system for determining user online time determines a user's online time based on the second time instance (which is the time of the first operation satisfying the second condition in a user visit) in a user visit, which is based on the first operation in a given time period. In other cases, the system may determine the online time based on the last operation in a given time period. In addition, when a system records user operations in real time, it may also determine the first and second time instances based on whether the time difference between the two adjacent operations exceeds a threshold value.

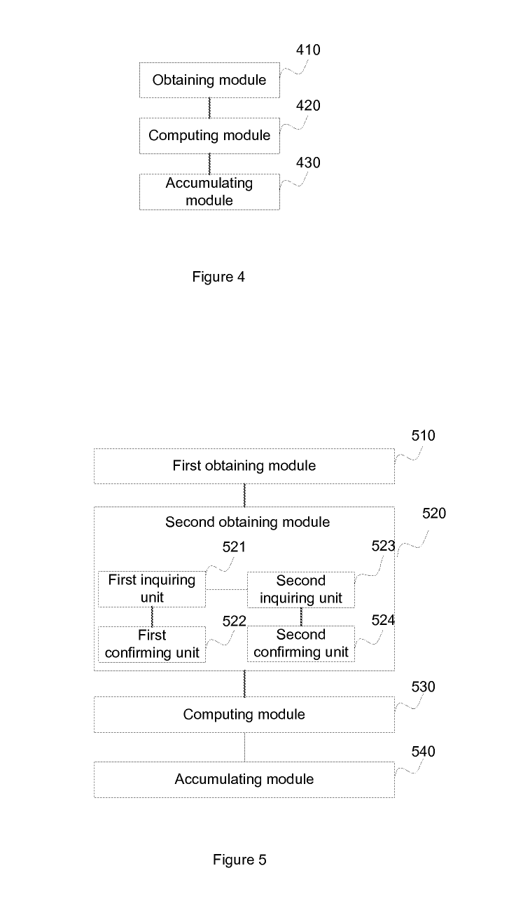

FIG. 4 shows an exemplary schematics diagram of a system for determining user online time. The system includes an obtaining module 410, a computing module 420, and an accumulating module 430. The obtaining module 410 may obtain a first time instance and a second time instance. The first time instance may be the time of the first operation during a user visit. The second time instance may the time of the last operation during the user visit. The computing module 420 may calculate the time difference between the first and second time instances. The accumulating module 430 may accumulate the total user online time by adding the time difference to the total.

Embodiments consistent with the present disclosure determine user online time based on the time of the user's first operation and the time of the user's last operation in one session. Embodiments consistent with the present disclosure may define the time for the first operation as the first time instance and the time for the last operation as the second time instance. Embodiments consistent with the present disclosure may calculate the time difference between the time instances. Embodiments consistent with the present disclosure may further add the length of the time difference to the user's total online time. Embodiments consistent with the present disclosure may determine user online time without checking the sign-in time and sign-off time of a user.

FIG. 5 shows an exemplary schematics diagram of a system for determining user online time. The system includes a first obtaining module 510, a second obtaining module 520, a computing module 530, and an accumulating module 540.

The first obtaining module 510 may obtain the times correspond to the operations in a given time period. The second obtaining module 520 may obtain a first time instance and a second time instance. The first time instance may be the time of the first operation during a user visit. The second time instance may the time of the last operation during the user visit. The second obtaining module 520 may include a first inquiring unit 521, a first confirming unit 522, a second inquiring unit 523, and a second confirming unit 524.

The first inquiring unit 521 may check whether the operations in the group of operations satisfy a first condition. The first condition may include whether the time for an operation is after the time for the previous operation for more than a given threshold amount of time. The second obtaining module 520 may set the threshold. In one example, if a user has not performed an operation on the website for a period over the threshold, the second obtaining module 520 may determine that the use has gone offline.

The first confirming unit 522 may then set the time for each operation that satisfies the first condition as a first instance.

The second inquiring unit 523 may check whether the operations after the operations meeting the first condition satisfy a second condition. The second condition may include whether the time for an operation is before the time for a next operation for more than a given threshold amount of time. The second obtaining module 520 may set the threshold, which may correspond to the time threshold for user going offline.

The second confirming unit 524 may set the time corresponding to the first operation satisfying the second condition for each visit as the second instance.

The computing module 530 may calculate the time difference between the first and second time instances. The accumulating module 540 may accumulate the total user online time by adding the time difference to the total.

Embodiments consistent with the present disclosure determine user online time based on the time of the user's first operation and the time of the user's last operation in one session. Embodiments consistent with the present disclosure may define the time for the first operation as the first time instance and the time for the last operation as the second time instance. Embodiments consistent with the present disclosure may calculate the time difference between the time instances. Embodiments consistent with the present disclosure may further add the length of the time difference to the user's total online time. Embodiments consistent with the present disclosure may determine user online time without checking the sign-in time and sign-off time of a user.

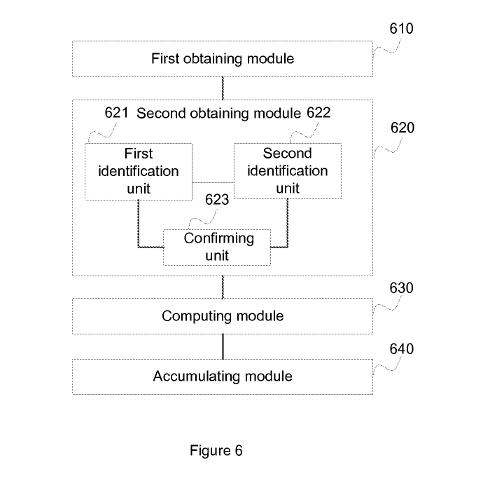

FIG. 6 shows an exemplary schematics diagram of a system for determining user online time. The system includes a first obtaining module 610, a second obtaining module 620, a computing module 630, and an accumulating module 640.

The first obtaining module 610 may obtain the operations and the times correspond to the operations in a given time period. Further, the first obtaining module 610 may obtain the operations and the times of the operations from a given time to the present.

The second obtaining module 620 may obtain a first time instance and a second time instance. The first time instance may be the time of the first operation during a user visit. The second time instance may the time of the last operation during the user visit. The second obtaining module 620 may include a first identification unit 621, a second identification unit 622, and a confirming unit 623.

The first identification unit 621 may check whether the operations in the group of operations satisfy a first condition. The first condition may include whether the time for an operation is after the time for the previous operation for more than a given threshold amount of time. The second obtaining module 620 may set the threshold. In one example, if a user has not performed an operation on the website for a period over the threshold, the second obtaining module 620 may determine that the use has gone offline.

The second identification unit 622 may check whether the operations after the operations meeting the first condition satisfy a second condition. The second condition may include whether the time for an operation is before the time for a next operation for more than a given threshold amount of time. The second obtaining module 620 may set the threshold, which may correspond to the time threshold for user going offline.

The confirming unit 623 may then set the time for each operation that satisfies the first condition as a first time instance. The second confirming unit 623 may set the time corresponding to the first operation satisfying the second condition for each visit as the second time instance.

The computing module 630 may calculate the time difference between the first and second time instances. The accumulating module 640 may accumulate the total user online time by adding the time difference to the total.

Embodiments consistent with the present disclosure determine user online time based on the time of the user's first operation and the time of the user's last operation in one session. Embodiments consistent with the present disclosure may define the time for the first operation as the first time instance and the time for the last operation as the second time instance. Embodiments consistent with the present disclosure may calculate the time difference between the time instances. Embodiments consistent with the present disclosure may further add the length of the time difference to the user's total online time. Embodiments consistent with the present disclosure may determine user online time without checking the sign-in time and sign-off time of a user.

Consistent with embodiments of the present disclosure, one or more non-transitory storage medium storing a computer program are provided to implement the system and method for determining user online time. The one or more non-transitory storage medium may be installed in a computer or provided separately from a computer. A computer may read the computer program from the storage medium and execute the program to perform the methods consistent with embodiments of the present disclosure. The storage medium may be a magnetic storage medium, such as hard disk, floppy disk, or other magnetic disks, a tape, or a cassette tape. The storage medium may also be an optical storage medium, such as optical disk (for example, CD or DVD). The storage medium may further be semiconductor storage medium, such as DRAM, SRAM, EPROM, EEPROM, flash memory, or memory stick.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems, various systems for determining user online time may be implemented. For example, a website may use the system to determine a user's online time by tracking all user operations in a given time frame. The system may start from checking the time of the last operation of the user and the time difference between the last operation and the previous operation. The system may also set a threshold value to determine whether the user has signed out. If the time difference is shorter than the threshold value, the system may add the value of the time difference to the user's total online time.

In another example, when a user signs onto a web portal, such as QQ's website (www.qq.com), he may visit a Hog website and perform user operations. He may then visit other related websites and return to the blog website without needing to sign in for a second time. The server of the blog website may then determine the actual length of time the user is on the blog website using embodiments of the present disclosure.

By determining user online time using embodiments of the present disclosure, a website may better track its user operations and usage and deliver better targeted services.

What is claimed is:

1. A method for determining user online time, comprising:
determining a first time instance, the first time instance corresponding to a first user operation during one user visit;
determining a second time instance, the second time instance corresponding to a last user operation during the user visit;
determining a difference between the first time instance and the second time instance; and
adding the difference to the user online time.

2. The method according to claim 1, further comprising:
obtaining operations and operation times of all operations of a user;
determining whether an operation meets a first condition, the first condition being whether the time for the operation is after a time for a previous operation for more than a given threshold amount of time; and
determining a first time instance based on the time for an operation meeting the first condition.

3. The method according to claim 2, further comprising:
defining the threshold amount of time as one user visit;
determining whether an operation after the operation corresponding to the first time instance meets a second condition, the second condition being whether time different between the time of the operation and a time of a subsequent operation is more than the threshold amount of time; and
determining a second time instance based on the time for an operation meeting the second condition.

4. The method according to claim 1, further comprising:
defining a threshold amount of time as a user visit; and
obtaining operations and operation times of all operations during the user visit.

5. The method according to claim 2, further comprising:
obtaining all user operations, including operation times, of a user in real time.

6. A system for determining user online time including a server for implementing functions supporting determination of the user online time, the server comprising:
an obtaining module configured to obtain a first time instance, the first time instance corresponding to a first user operation during one user visit and to obtain a second time instance, the second time instance corresponding to a last user operation during the user visit;
a computing module configure to determine a difference between the first time instance and the second time instance; and
an accumulating module configured to add the difference to the user online time.

7. The system according to claim 6, wherein the obtaining module is further configured to obtain operations and operation times of all operations of a user.

8. The system according to claim 7, wherein the obtaining module includes a first inquiring unit configured to determine whether an operation meets a first condition, the first condition being whether the time for the operation is after a time for a previous operation for more than a given threshold amount of time.

9. The system according to claim 8, wherein the obtaining module includes a first confirming unit configured to determine a first time instance based on the time for an operation meeting the first condition.

10. The system according to claim 6, wherein the obtaining module is further configured to define a threshold amount of time as one user visit.

11. The system according to claim 9, wherein the obtaining module includes a second inquiring unit configured to determine whether an operation after the operation corresponding to the first time instance meets a second condition, the second condition being whether time different between the time of the operation and a time of the subsequent operation is more than the threshold amount of time.

12. The system according to claim 11, wherein the obtaining module includes a second confirming unit configured to determine a second time instance based on the time for an operation meeting the second condition.

13. The system according to claim 10, wherein the obtaining module is further configured to record operations and operation times of all operations during the user visit.

14. The system according to claim 6, wherein the obtaining module is further configured to obtain all user operations, including operation times, of a user in real time.
